(19) United States
(12) Patent Application Publication
(10) Pub. No.: US 2026/0307162 A1
(43) Pub. Date: Oct. 8, 2026

(54) SYSTEM AND METHOD FOR ADJUSTING WELDING SIGNALS

(71) Applicant: Lincoln Global, Inc., Cleveland, OH (US)

(72) Inventors: Judah B. Henry, Painesville, OH (US); Todd E. Kooken, Solon, OH (US); Sheldon A. Wray, Eastlake, OH (US); Christopher J. Williams, Norham (GB)

(21) Appl. No.: 19/097,977

(22) Filed: Apr. 2, 2025

(51) Int. Cl. B23K 9/095; B23K 9/10

(52) U.S. Cl. CPC B23K 9/0953; B23K 9/0956; B23K 9/1006

(57) ABSTRACT

A welding system includes a welding torch with a sensor configured to detect a position and orientation of the welding torch relative to a welding path. The system also includes a controller communicatively coupled with the sensor. The controller includes logic to receive the position and orientation of the welding torch relative to the welding path, and generate an updated welding signal based on the detected position and orientation.

### FIELD

The present disclosure generally relates to welding systems and methods, and more specifically, a welding system configured to dynamically adjust welding signals based on the position and orientation of a welding torch relative to a weld path in real time.

### BACKGROUND

Welding is a manufacturing process used to join metals in a variety of industries where quality is of the utmost importance, for example, in aerospace, oil and gas, power generation, and medical device industries. A quality weld is critical because it impacts the strength and durability of the resulting product or product assembly. When welding in non-horizontal or flat weld positions, gravity can significantly influence weld quality based on its tendency to cause molten weld metal to flow downward, creating issues like poor fusion, inconsistent bead size, warping, distortion, or part misalignment. Given the foregoing, welders often must compensate for gravity by manually adjusting heat input, welding speed, and/or by employing a special welding technique (e.g., a weaving technique). However, many welders do not have the skillset to make such adjustments or perform such welding techniques. Moreover, making manual adjustments can hinder the productivity of a welding process. It is desirable to provide a welding system and method that compensates for the effects of gravity during a welding process in real-time and without operator intervention.

### SUMMARY

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect, there is provided a welding system including a welding torch including a sensor. The sensor is configured to detect motion data at a point along a weld path. A controller is communicatively coupled with the sensor. The controller includes logic to receive the motion data, generate an updated welding signal based on the motion data, wherein the updated welding signal includes a waveform type, and implement the waveform type during the welding process.

In accordance with an embodiment, the motion data includes a travel speed, a position, and an orientation of the welding torch relative to the weld path.

In accordance with an embodiment, the controller receives the motion data at a first point along the weld path and at a second point along the weld path, and the controller includes logic to generate a first waveform type at the first point, and a second waveform type at the second point, wherein the first waveform type is different than the second waveform type.

In accordance with an embodiment, the first point along the weld path is at a first weld position, and the second point along the weld path is at a second weld position different than the first weld position. The first waveform type includes a first pinch current level and the second waveform type includes a second pinch current level. The first pinch current level exceeds the second pinch current level.

In accordance with an embodiment, the first point along the weld path is at a first weld position, and the second point along the weld path is at a second weld position different than the first weld position. The first waveform type includes a first peak current level and the second waveform type includes a second peak current level. The first peak current level exceeds the second peak current level.

In accordance with an embodiment, the controller further includes logic to process the motion data via an artificial intelligence model to generate an absolute position and orientation of the welding torch relative to the weld path, and generate the updated welding signal based on the absolute position and orientation.

In accordance with an embodiment, the artificial intelligence model comprises a deep learning neural network comprising an input layer, one or more hidden layers, and an output layer, wherein the artificial intelligence model receives the motion data in the input layer to determine the absolute position and orientation at the output layer.

In accordance with an embodiment, the system further includes a welding power source, and the welding power source includes a pulse width modulator component. The controller includes logic to control the pulse width modulator component to execute the updated welding signal.

In accordance with an embodiment, the waveform type includes a background current level, a pinch current level, a peak current level, and a low current level, wherein low current level is less than the background current level, and the controller includes logic to execute the low current level when welding wire supplied via the welding torch shorts a workpiece to minimize spatter.

In accordance with yet another aspect, a method of adjusting a welding signal during a welding process includes receiving a first position and orientation of a sensor at a first point along a weld path, and a second position and orientation of the sensor at a second point along the weld path. The method also includes generating a first updated welding signal based on the first position and orientation, and generating a second updated welding signal based on the second position and orientation. The first updated welding signal includes a first waveform type, and the second updated welding signal includes a second waveform type. The second waveform type is different than the first waveform type.

In accordance with an embodiment, the first waveform type includes a first pinch current level, and the second waveform type includes a second pinch current level. The second pinch current level is different than the first pinch current level.

In accordance with an embodiment, the method further includes implementing the first updated welding signal at the first point along the weld path, and implementing the second updated welding signal at the second point along the weld path.

In accordance with an embodiment, the method further includes processing the first position and orientation as an input to an artificial intelligence model to determine a first position and orientation of the welding torch relative to the weld path at the first point, and processing the second position and orientation of the sensor as another input to the artificial intelligence model to determine a second position and orientation of the welding torch relative to the weld path at the second point. In addition, the method includes generating a first updated welding signal based on the first position and orientation, and generating a second updated welding signal based on the second position and orientation.

In accordance with an embodiment, the method also includes executing a pulse width modulation control to implement the first updated welding signal at the first point, and executing the pulse width modulation control to implement the second updated welding signal at the second point.

In accordance with an embodiment, the sensor comprises an inertial measurement unit affixed to a welding torch during a welding process.

In accordance with an embodiment, the first waveform type includes a first peak current level, and the second waveform type includes a second peak current level, wherein the second peak current level is different than the first peak current level.

In accordance with an embodiment, the first waveform type includes a first background current level and the second waveform type includes a second background current level, wherein the first background current level is different than the second background current level.

In accordance with yet another aspect, a system for welding includes a welding power source, a welding torch, a sensor affixed to the welding torch, and a controller. The welding power source includes output circuitry configured to generate a welding signal. The welding torch is operatively connected to the welding power source and is configured to generate a molten weld puddle along a weld path. The controller includes a processor that includes logic to receive sensor data from the welding torch. The sensor data includes at least one of a position, orientation, and travel speed of the welding torch relative to a weld path. The processor also includes logic to generate a first updated welding signal at a first position along the weld path based on the sensor data at the first position, wherein the first updated welding signal includes a first waveform type. The processor also includes logic to generate a second updated welding signal at the second position along the weld path based on the sensor data at the second position, wherein the second updated welding signal includes a second waveform type.

In accordance with an embodiment, the first waveform type is different than the second waveform type.

In accordance with an embodiment, the controller further includes logic to control the output circuitry of the welding power source to implement the first welding signal at the first position along the weld path and control the output circuitry to implement the second welding signal at the second position along the weld path.

Numerous aspects of the general inventive concepts will become readily apparent from the following detailed description of exemplary embodiments, from the claims, and from the accompanying drawings.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a perspective view of an example semi-automatic arc welding system;

FIG. 2 is a schematic illustration of an example orbital welding system configured to perform a weld about a circumference of a pipe joint;

FIG. 3 is a schematic illustration of an example welding system according to the present disclosure;

FIG. 4 is an illustration of an example welding torch according to the present disclosure, performing a vertical down weld;

FIG. 5 is an illustration of an example welding torch according to the present disclosure, performing a flat weld with a backstep technique;

FIG. 6 is an illustration of an example welding torch according to the present disclosure, performing a weld about a circumference of a pipe joint;

FIG. 7 illustrates an example waveform used in an arc welding process, according to an embodiment of the present disclosure;

FIG. 8 illustrates an example waveform used in an arc welding process, according to another embodiment of the present disclosure;

FIG. 9 illustrates an example waveform, used in an arc welding process, according to yet another embodiment of the present disclosure; and

FIG. 10 illustrates a flow chart of an exemplary method for adjusting a welding signal during a welding process, according to an embodiment of the present disclosure.

### DETAILED DESCRIPTION

The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

“Signal,” as used herein includes, but is not limited to, one or more electrical signals, including analog or digital signals, one or more computer instructions, a bit or bit stream, or the like. The term “signal” may correspond with “commands,” “data,” “information,” or “parameters” communicated from one device or component to another during a welding process.

“Logic,” synonymous with “circuit” as used herein, includes but is not limited to hardware, firmware, software and/or combinations of each to perform a function(s) or an action(s). For example, based on a desired application or needs, logic may include a software-controlled microprocessor, discrete logic such as an application specific integrated circuit (ASIC), or other programmed logic device and/or controller. Logic may also be fully embodied as software.

“Software,” as used herein, includes but is not limited to one or more computer readable and/or executable instructions that cause a computer, processor, logic, and/or other electronic device to perform functions, actions, and/or behave in a desired manner. The instructions may be embodied in various forms such as routines, algorithms, modules, or programs including separate applications or code from dynamically linked sources or libraries.

“Component,” as used herein can be defined as a portion of hardware, a portion of software, or a combination thereof. A portion of hardware can include at least a processor and a portion of memory, wherein the memory may include instructions to execute a software program. A component may be associated with a device.

“Controller,” as used herein, refers to the logic circuitry and/or processing elements and associated software, programs, or artificial intelligence models utilized to execute the disclosed methodologies and processes for controlling a material processing application disclosed herein. The controller may include a processor and a storage device, and may take on various forms, for example, a workstation, server, computing cluster, a server, server farm, or any other data processing system or computing device. Due to the ever-changing nature of computing devices and networks, the description of the various examples of a controller described herein, and depicted in the associated drawings, is intended only as an example for purposes of illustrating some embodiments. Many other configurations of the controller are contemplated to fall within the scope of the present disclosure.

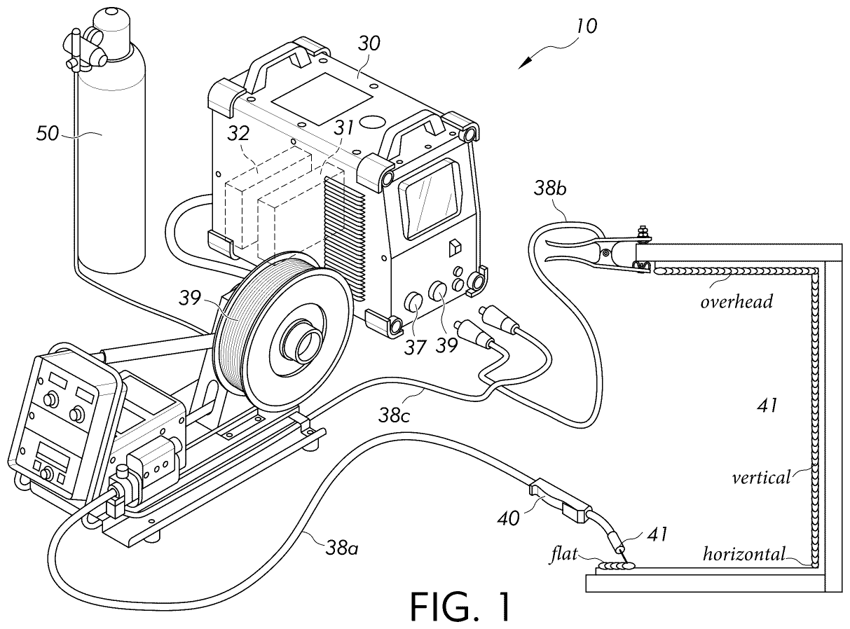

Referring to FIG. 1, an example semi-automatic gas metal arc welding (GMAW) system 10 is shown. The welding system 10, in general, includes a power source 30, a wire feeder 35, a welding torch 40, and a shielding gas supply source 50. The wire feeder 35 may comprise a motor operable to rotate oppositely disposed drive rolls (not shown) configured to compress and push welding wire from a wire source (e.g., a spool of welding wire 39) into the welding torch 40 via a weld cable 38a. The power source 30 may include a first output terminal 37 operatively connected to a workpiece via a ground cable or work lead 38b, and a second output terminal 39 operatively connected to the welding torch 40 via a feeder cable 38c (connecting the power source 30 to the wire feeder 35) and the weld cable 38a (connecting the wire feeder 35 to the welding torch 40).

The first output terminal 37 may be configured to supply current to the welding wire (serving as a consumable electrode) via a contact tip 41 of the welding torch 40 through which the welding wire extends. In this manner, the welding torch 40 may be configured to establish a welding arc between the contact tip 41 and the workpiece to produce a molten weld puddle. The power source 30 may include output circuitry 31 configured to generate various welding signals, including, but not limited to, a welding current, an output voltage, a welding waveform, an arc on/off signal, and the like.

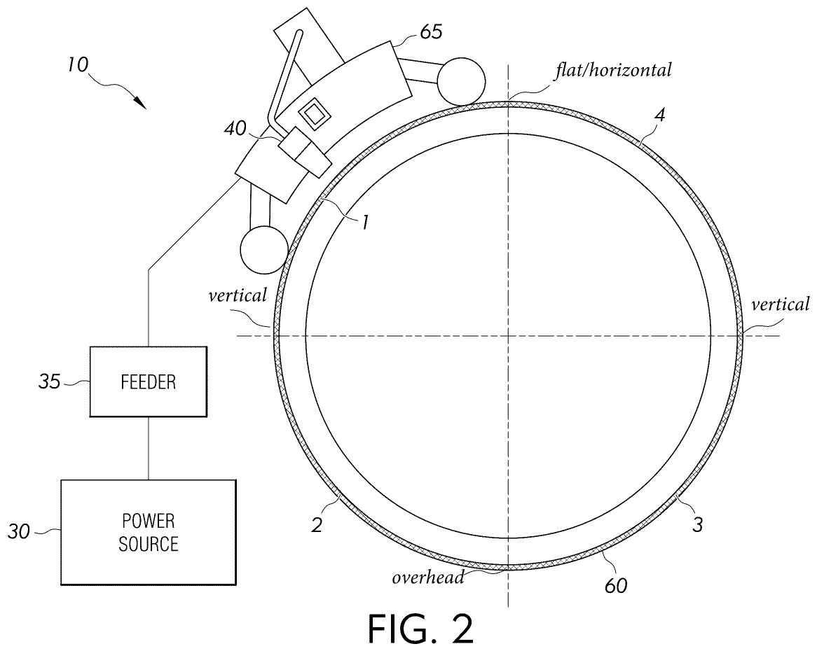

The power source 30 may also include a controller 32 (e.g., a microcontroller or other processing unit therein) operatively connected to the output circuitry 31. The controller 32 may be configured to generate and send commands to the output circuitry 31 to generate the welding signals based on user commands (e.g., a desired welding current, desired welding waveform, etc.). In the embodiment shown, the welding system 10 is shown in relation to a workpiece, requiring welding in various weld positions, namely a flat position, a horizontal position, a vertical position, and an overhead position as shown. In some embodiments, the welding system 10 may be utilized to weld in other positions, for example, around a circumference of an object. For instance, referring to FIG. 2, the welding system 10 may be employed to perform welding about a circumference of adjoining sections of a pipe. In this embodiment, the welding torch 40 is attached to a moving carriage 65 configured to move about the circumference of the pipe via a rail 60. In this manner, the welding torch 40 is configured to perform a weld around the circumference of the pipe, such that the torch 40 encounters a plurality of dynamically changing weld positions, for example, a plurality of positions along a weld path moving downward from a flat/horizontal position to a vertical position along arc 1, along a weld path moving downward from the vertical position to an overhead position along arc 2, along a weld path moving upward from an overhead position to another vertical position along arc 3, and along a weld path moving upward from the other vertical position to the flat/horizontal position along arc 4.

Producing a quality weld in the various weld positions shown in FIGS. 1 and 2 may be cumbersome for a user, particularly given the force of gravity, which tends to pull molten metal downward, making it challenging to keep a weld pool in place and create a consistent weld (e.g., consistent bead size, bead profile, penetration, etc.) at the various weld positions. Such gravity-induced challenges may cause defects such as undercuts or poor fusion, compromising the quality of the resulting weld. Moreover, implementing a uniform welding signal to produce a weld at the various weld positions may not be suitable considering the effects of gravity as discussed herein.

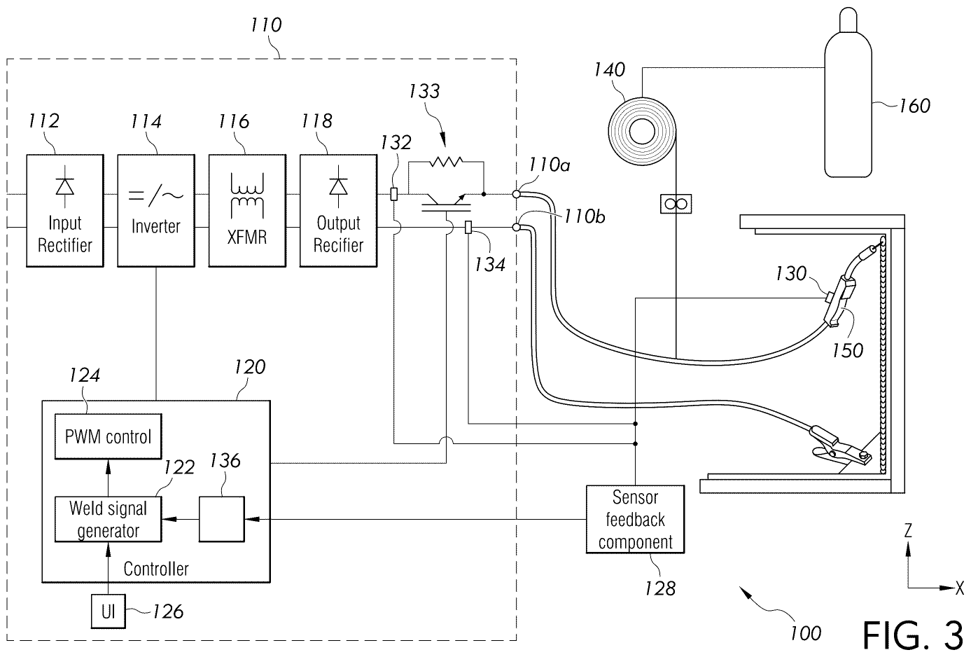

Referring to FIG. 3, a welding system 100 according to the present disclosure is shown. The welding system 100, in general, includes a power source 110, a welding torch 150, a wire feeder 140, and a gas supply source 160. In some embodiments, the power source 110 may be a constant voltage (CV) power source. Although it is contemplated that the power source 110 may be a multi-process welder, e.g., possessing both CV and constant current (CC) capabilities.

The power source 110 receives electrical energy (from an external source not shown) for generating and supplying welding signals to the welding torch 150 and the wire feeder 140. The power source 110 may include output circuitry, for example, an input rectifier 112 configured to convert alternating current (AC) to direct current (DC), and an inverter circuit 114 configured to invert DC into a high-frequency AC. For this purpose, the inverter circuit 114 may comprise a plurality of semiconductor switches (e.g., IGBTs or MOSFETs) configured to switch at or above 20 kHz. The output circuitry may also include a step-down transformer 116 configured to convert high-frequency, high voltage AC (supplied from the inverter circuit 114) to low voltage, high frequency AC. In addition, the output circuitry may include an output rectifier 118 configured to convert the AC back to DC. The power source 110 may be configured to supply direct current electrode positive (DC+), wherein the DC+current is supplied from a positive output terminal 110a to the welding torch 150. The power source 110 may also be configured to supply direct current electrode negative (DC−), wherein the DC-current is supplied from a negative output terminal 110b to the workpiece (e.g., via a work clamp connection). The power source 110 may also be configured to supply AC or a variable polarity current to the welding torch 150.

The power source 110 may include a controller 120 operatively connected to the output circuitry for controlling the welding signals generated by the power source 110. In the embodiment shown, the controller 120 is shown as forming a part of the power source 110. In other embodiments, the controller 120 may embody a standalone component operatively connected to the power source 110. In some embodiments, the power source 110 may include a wireless communication component (e.g., one or more Bluetooth modules, Wi-Fi modules, an RF system, one or more Zigbee devices, one or more IoT sensors, one or more transceivers, etc.) configured to communicate with the controller 120, for instance, wherein the controller 120 is provided as a standalone component, or in the form of a remote server or cloud-based platform. The controller 120 may include a weld signal generator 122 and a pulse-width modulation (PWM) control component 124.

The weld signal generator 122 may be configured to receive, generate, and transmit welding signal commands during the welding process. The welding signal commands may relate to welding signals, including, but not limited to, a welding process type (e.g., GMAW, gas-tungsten arc welding-GTAW, flux cored arc welding-FCAW, shielded metal arc welding SMAW, sub arc welding-SAW, a welding wire type or diameter, a polarity (e.g., DC+, DC−, AC, variable polarity), a transfer mode (e.g., short circuit, spray transfer, pulsed spray transfer, etc.), a workpiece material type, a welding current, a voltage out, a waveform type, an arc initiation signal, an arc termination signal, a shielding gas flow rate, a welding frequency, DC or AC offset values, an AC balance control, a wire feeder setting (e.g., a wire feed speed), AC frequency control, and the like.

In some embodiments, the weld signal generator 122 may be communicatively coupled with a user interface 126 operable to receive user inputs corresponding to desired welding signals for a welding process. The user interface 126 may comprise a control panel or a graphical user interface. In some embodiments, the user interface 126 may include one or more control knobs, buttons, sliders, touch pads (or screens), cameras (for visual command recognition or for image capture (e.g., of a tag or QR code on a scanned part/workpiece to be welded)), a keyboard, a pointing device (e.g., a mouse, a trackball, a touchpad), a scanner, audio input devices (e.g., voice recognition devices, microphones, etc.) and/or other types of known input devices or user interfaces that facilitate communication between a user and a welding power source.

The PWM control component 124 may be configured to control (e.g., implement, adjust, terminate) the welding signals transmitted from the weld signal generator 122. For instance, the PWM control component 124 may control output circuitry (e.g., the inverter circuit 114), for example, by rapidly switching the transistors thereof at a predetermined high frequency to precisely regulate the power delivered via the power source 110 to achieve a desired welding signal in real-time. In embodiments, the PWM control component 124 may be configured to adjust the duty cycle (ratio of “on/off” time) to achieve a desired welding signal, for instance, a desired waveform, as discussed in detail below.

In some embodiments, the PWM control component 124 may form part of the weld signal generator 122, i.e., instead of being an independent component of the controller 120. For instance, the weld signal generator 122 may be configured to execute a pulse width modulation control logic to regulate the power delivered via the power source 110 to attain a desired welding signal.

The welding system 100 may also include a sensor feedback component 128 configured to measure, retrieve, store, time stamp, and/or communicate process data retrieved (e.g., measured, monitored, detected, etc.) during the welding process in real-time. The sensor feedback component 128 may take on any suitable form, for example, a data acquisition system (DAQ), a data logger, a programmable digital multimeter, and the like.

The sensor feedback component 128 may be communicatively coupled with one or more sensors configured to monitor, measure, or detect the process data during a welding process in real-time. The one or more sensors may include, but not be limited to, a motion sensor 130, a current sensor 132, and a voltage sensor 134. The current sensor 132 (e.g., a current transformer or shunt) may be configured to detect and transmit welding current feedback to the controller 120, and the voltage sensor 134 may be configured to detect and transmit welding voltage feedback (e.g., an arc or output voltage) to the controller 120. The motion sensor 130 may be configured to detect motion data corresponding with the progression of the welding torch 150 relative to a weld path in real-time, wherein the motion data defines the movement (e.g., instantaneous position, orientation, travel speed, etc.) of the welding torch 150 in a three-dimensional (3D) space. In the embodiment shown, the motion sensor 130 is positioned on a handle of the welding torch 150. It is contemplated that the motion sensor 130 may be disposed at different locations, for example, adjacent to a nozzle of the welding torch, or on a conductor tube thereof, or at a junction of the conductor tube and the handle, etc. The motion sensor 130 may be configured to communicate motion data to the sensor feedback component 128 via any suitable wired or wireless connection (e.g., via Bluetooth modules, Wi-Fi modules, an RF system, one or more Zigbee devices, one or more IoT sensors, one or more transceivers, etc.).

The motion data detected by the motion sensor 130 may include a position and an orientation of the welding torch 150 relative to the workpiece (e.g., relative to a weld path thereof). For example, the orientation may comprise a work angle (i.e., the angle at which the welding torch 150 is positioned relative to the workpiece) or a travel angle (i.e., the angle of the torch in relation to the direction of travel along a weld path). The motion data may also include, but not be limited to, a travel speed of the welding torch 150 as it moves along the weld path. In some embodiments, the motion sensor 130 may be configured to detect motion data in nine degrees of freedom. For example, it may be configured to detect a linear acceleration of the welding torch 150 along three axes x, y, and z (wherein the y axis extends into the page in the embodiment shown). Further, the motion sensor 130 may be configured to measure and detect an angular velocity of the welding torch 150 (e.g., rate of rotation) around the axes x, y, and z and/or an orientation of the welding torch 150 in a 3D space. Further still, the motion sensor 130 may be configured to measure and detect the magnetic field strength in the axes x, y, and z, which may be utilized to determine the direction in which the torch 150 is moving (referencing the Earth's magnetic field).

In this manner, the motion sensor 130 may comprise some or all of an accelerometer, a gyroscope, and a magnetometer for detecting the motion data (e.g., the acceleration for determining travel speed, rotation/orientation, and magnetic field strength). In some embodiments, the motion sensor 130 may comprise an inertial measurement unit (IMU) comprising the accelerometer, gyroscope, and magnetometer. It is contemplated that the motion sensor 130 may take on other forms, for example, a camera or a laser that detects markers or patterns placed along the weld path to ascertain a position and orientation of the welding torch 150 relative to the weld path, or a stereo camera or an infrared camera configured to project a 3D image of the weld path to ascertain the position and orientation data of the welding torch 150 relative to the weld path. It is also contemplated that the motion sensor 130 may comprise a LIDAR system (e.g., light detection and ranging) configured to emit a laser beam to provide distance measurements and generate a 3D image to ascertain the position and orientation data.

In addition to measuring, detecting, or monitoring welding current feedback, voltage feedback, and motion data, the welding system 100 may include sensors for measuring, detecting, or monitoring other forms of process data, for instance, 3D properties of the weld (e.g., weld size), a tool center point (TCP) (e.g., to ascertain where the welding wire exits the contact tip relative to the weld path), a heat affected zone of a weld via a scanner (e.g., an infrared camera and the like), or environmental workplace conditions via an environmental sensor (e.g., to detect temperature and humidity).

In some embodiments, the sensor data (e.g., motion data, welding current feedback, welding voltage feedback) may be retrieved, stored, and time-stamped by the sensor feedback component 128 for subsequent retrieval.

In the embodiment shown, the sensor feedback component 128 is a standalone component communicatively coupled with the controller 120 to communicate sensor data to the controller 120 in real time. It is contemplated that the sensor feedback component 128 may form part of the controller 120. In this manner, the controller 120 may comprise the logic to retrieve, store, and time stamp the sensor data in real time.

The controller 120 may include a processor 136 comprising logic to process the sensor data and determine updated welding signals based on the sensor data. In some embodiments, the processor 136 may embody a microprocessor, a microcontroller-based platform, a suitable integrated circuit, one or more field programmable gate arrays (FPGAs), and/or one or more application-specific integrated circuits (ASICs).

In some embodiments, the processor 136 may employ an artificial intelligence model, algorithm, or predefined rules that identifies and eliminates noise in the sensor data to refine the sensor data and determine updated welding signals based on the refined sensor data. For example, the noise may relate to noise in the motion data attributed to sensor drift over time. In some embodiments, the artificial intelligence model or algorithm may comprise a supervised, artificial neural network (e.g., a deep learning neural network comprising an input layer, one or more hidden layers, and an output layer) configured to receive the sensor data to identify noise (e.g., sensor drift). It is also contemplated that an unsupervised model may be utilized (e.g., wherein the inputs to the model are not categorized or defined). The input layer may be configured to receive some or all of the detected sensor data (e.g., motion data, welding current feedback, or welding voltage feedback) as inputs to detect patterns in identifying the noise, to thereby refine the sensor data (i.e., to eliminate noise) and determine updated welding signals based on the refined sensor data. In some embodiments, the processor 136 may employ an artificial intelligence model, algorithm, or other rules to generate other information, for example, a velocity or travel speed of the welding torch along the weld path, or in some embodiments, it may determine an absolute position of the welding torch (e.g., a TCP) based on the motion data of the sensor, considering the coordinate system of the sensor and/or the position of the sensor relative to the TCP to refine the sensor data to derive information regarding the absolute position, orientation, and travel speed of the welding torch 150.

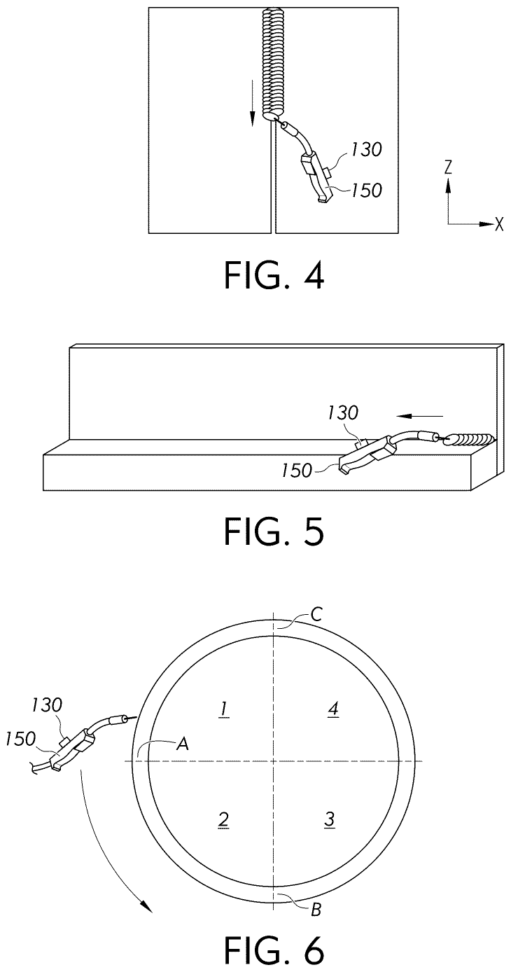

The updated welding signals may include, but not be limited to, an updated welding current, an updated output voltage, an arc on/off signal, an updated wire feed speed, and an updated waveform type employed for the welding process. For instance, the controller 120 may receive motion data from the motion sensor 130 indicating that the welding torch 150 is performing a weld along a vertical weld path, e.g., a vertical down progression (see FIG. 4). In some embodiments, the controller 120 may receive motion data detecting a certain welding technique, for instance, a weave pattern, as shown in FIG. 4. In some embodiments, the motion sensor 130 may use a base coordinate axis (e.g., an x coordinate axis), to derive motion data in other coordinate axes, for instance, to detect motion data relative to a z-coordinate axis, or to detect motion data relative to a y coordinate axis. In some embodiments, the motion data may comprise 3D vectors associated with the position and orientation of the welding torch 150 relative to the weld path in a 3D space. In this manner, the motion sensor 130 may be configured to detect motion data indicating that the welding torch 150 is performing a weld in one of a variety of weld positions, for example, but not limited to, a horizontal weld (e.g., a fillet weld as shown in FIG. 5), any one of the weld positions shown in FIG. 1, or at one of a plurality of weld positions about a circumference of an object (e.g., as shown in FIG. 6).

As noted above, the controller 120 may process the sensor data, and generate updated welding signals based on the sensor data in real-time that are optimal to provide a consistent weld (e.g., a consistent bead size, consistent profile, and consistent penetration, etc.). For instance, the controller 120 may receive motion data indicating that a welding torch 150 is performing a vertical down weld (e.g., FIG. 4) with a weave pattern, or moving along a downward trajectory (e.g., from a vertical weld position (at point A) to an overhead position (at point B) around a pipe, as shown in FIG. 6). In such embodiments, the controller 120 may update the welding signals (e.g., the waveform type, the welding current, wire feed speed, output voltage) employed for the welding process to provide for a consistent weld based on the motion data, accounting for the effects of gravity on the molten weld puddle. For example, in some embodiments, the controller 120 may decrease the wire feed speed when the motion data indicates that the welding torch 150 is moving along a downward trajectory to control the viscosity of the molten weld puddle, e.g., to prevent it from becoming too fluid, which may disadvantageously cause the molten weld puddle to droop downward based on gravity. In other examples, the controller may increase the wire feed speed, for example, when the motion data indicates that the welding torch is resuming along a flat/horizontal weld progression to increase the fluidity of the molten weld puddle.

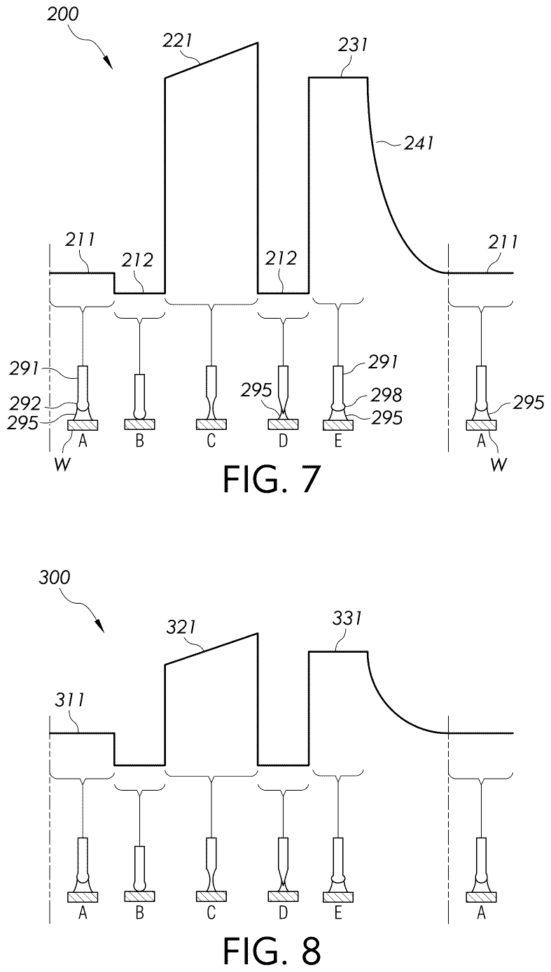

In other examples, an updated welding signal may comprise an updated waveform type based on the motion data. For example, referring to FIG. 7, an example of a first waveform type 200 is shown that is particularly optimal for welding in the vertical weld position. The first waveform type 200 may comprise a background phase providing a background current level 211, a pinch current phase providing a monotonically increasing pinch current level 221, a peak current phase providing a peak current level 231, and a tail-out current phase providing a monotonically decreasing tail-out current level 241.

During the background current phase, an electric arc 295 is sustained between the electrode 291 and the workpiece W producing a molten metal ball 292 on a distal end of the electrode 291 (see stage A in FIG. 7). At stage B, the molten metal ball 292, still connected to the electrode 291, shorts to the workpiece W, which can be detected via a low output voltage level, e.g., about 20 volts or less. When the short occurs, the arc 295 is extinguished and the current level of the first waveform 200 is dropped below the background current level 211 to a low current level 212, allowing the molten ball 292 to smoothly wet into a puddle on the workpiece W and minimize weld spatter. This may be done, for example, by actuating a current reducer circuit 133 (FIG. 3) of the power source 110 (e.g., comprising a switch and a resistor).

During the pinch current phase, the current level of the first waveform type 200 is increased monotonically (e.g., ramped upward) above the background current level 211, providing an increasing pinch current level 221, causing the shorted molten metal ball 292 to begin to pinch off from the distal end of the electrode 291 into the puddle of the workpiece W, as shown in stage C of FIG. 7. The inventors have unexpectedly found that a pinch current level 221 having a higher magnitude (e.g., in comparison to a lower pinch current level 321, as shown in FIG. 8) is advantageous to facilitate separating the shorted molten metal ball 292 from the distal end of the electrode 292 (e.g., to push the molten metal ball into the weld puddle), particularly in view of gravity when welding at or near the vertical position, which may hinder the molten metal ball to separate and pull the molten metal ball to flow or droop downward, compromising the quality and consistency of the resulting weld. As the molten metal ball 292 is about to pinch off from the electrode 291, the current level of the waveform 200 may be dropped below the background current level 211 to a current level 212 to avoid spatter (e.g., via the current reducer circuit 133 (FIG. 3)), and an arc 295 may be re-established between the electrode 291 and the workpiece W.

Once the arc 295 is re-established, the first waveform type 200 enters the peak current phase. During the peak current phase, the current level of the first waveform type 200 is increased to and held at the peak current level 231. In accordance with an embodiment, the peak current level 231 establishes an arc 295 between the electrode 291 and the workpiece W of sufficient strength to begin forming the next molten metal ball 298 at the distal end of the electrode 291. In the embodiment shown, the peak current level 231 is of a higher magnitude (e.g., in comparison to the peak current level 331 of FIG. 8). The inventors have unexpectedly found that a peak current level possessing a higher magnitude is advantageous to facilitate forming the next molten metal ball 298 in a manner that counters gravity when welding at or near the vertical position, which otherwise would hinder the consistent formation of the next the molten metal ball 298, e.g., by pulling the molten metal ball to droop or flow downward while it is being formed. In such embodiments, the background current level 211 may be decreased to a lower magnitude to compensate for the higher peak and pinch current levels, e.g., to provide for a consistent welding output (e.g., consistent current level). In this manner, the first waveform type 200 (with pinch and peak current levels each possessing a higher magnitude and background current levels each possessing a lower magnitude) is particularly suitable for when welding at or near the vertical weld position to provide for consistent weld quality weld, while accounting for the effects of gravity.

After the peak current phase, the first waveform type 200 enters the tail-out current phase. During the tail-out current phase, the current level of the first waveform type 200 monotonically (e.g., exponentially) decreases toward the background current level 211 providing the decreasing tail-out current level 241. After the tail-out current phase, the background current phase is again entered, initiating a subsequent waveform cycle beginning at stage A.

Referring to FIG. 8, an example of an updated welding signal in the form of a second waveform type 300 is shown. The second waveform type 300 includes similar elements of the first waveform type 200. As such, a description of similar features has been omitted for brevity. The second waveform type 300 defines a higher background current 321 than the background current of the first waveform type 200 (FIG. 7), a lower pinch current level 321 than the pinch current level 221 of the first waveform type 200 (FIG. 7), and a lower peak current 331 than the peak current 231 of the first waveform type 200 (FIG. 7). The second waveform type 300 may be particularly suitable when welding in or near the flat or horizontal position, wherein the force of gravity is less impactful since the weld is supported thereunder by the workpiece/substrate material. As such, the inventors have discovered that a lower pinch current level and a lower peak current level are sufficient to facilitate separating a molten metal ball and forming a new molten metal ball, respectively. Further still, because the pinch and peak current levels are lower, the background current level 311 may be of a higher magnitude to compensate for the lower peak and pinch current levels to provide for a consistent weld output (e.g., consistent current level).

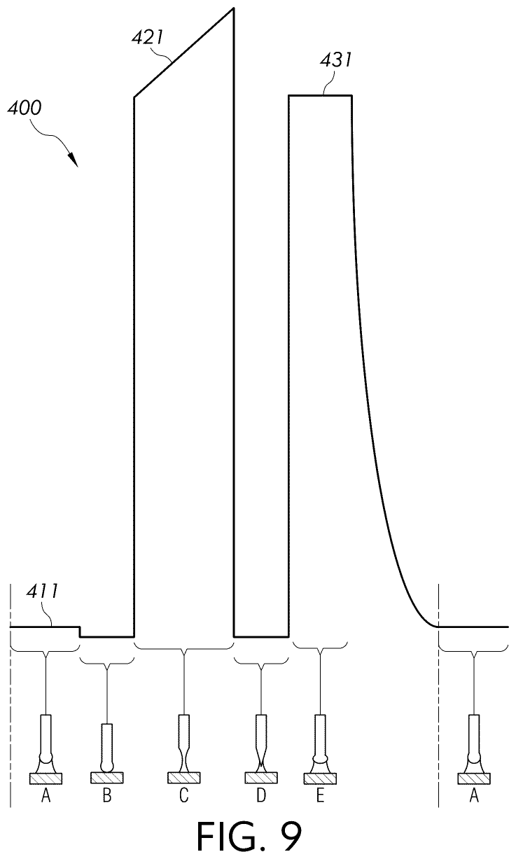

In this manner, the controller 120, may be configured to implement an updated welding signal based on the motion data, for example, to the first waveform type 200 when welding in or near the vertical weld position, and to the second waveform type 300 when welding in or near the flat/horizontal position. Although it should be understood that the controller 120 may utilize a variety of other waveform types based on the motion data, that are particularly optimal based on the detected position and orientation in real time. For instance, the magnitude of the pinch, peak, and background current levels may be somewhere between the magnitudes of the respective pinch, peak, and background current levels of the first and second waveform types 200 and 300, for example, if the motion sensor 130 detects a position and orientation somewhere between point C in FIG. 6 (a flat horizontal position) and point A in FIG. 6 (a vertical position). In this manner, it is contemplated that the controller 120 may update the waveform type (in real time) based on the detected position and orientation at a plurality of positions and orientations between two points defining a quadrant of a pipe cross section, e.g., a plurality of positions and orientations between points A and B (quadrant 2), or between B and C (quadrants 3 and 4) in FIG. 6. For instance, the controller 120 may receive motion data indicating that the torch is progressing toward an overhead weld position (e.g., from point a toward point B in FIG. 6). In this embodiment, the controller 120 may implement a third waveform type 400 (FIG. 9), wherein the pinch and peak current levels exceed the pinch and peak current levels of the first waveform type 200 (FIG. 7) to compensate for the effect of gravity (to facilitate bead separation), which is more significant at an overhead positions than a vertical position. In this manner, it should be understood that the controller 120 may implement a wide variety of waveform types based on the detected motion data (e.g., weld position and orientation), to provide for a weld comprising a consistent quality (e.g., consistent bead size, profile, and penetration), accounting for the effect of gravity at each of a plurality of positions and orientations.

In other embodiments, as noted above, the controller 120 may update other welding signals based on the motion data, for instance, the wire feed speed at one position and/or orientation, a welding current and/or arc voltage at another position and/or orientation, or any combination of the aforesaid welding signals including the waveform type. In some embodiments, the processor 136 of the controller 120 may comprise logic to execute an artificial intelligence model or algorithm, for example, an artificial neural network (e.g., a deep learning neural network) to generate updated welding signals, for example, an optimal wire feed speed, an welding current, an optimal voltage, polarity, or optimal waveform type, at each of a plurality of positions along a weld path.

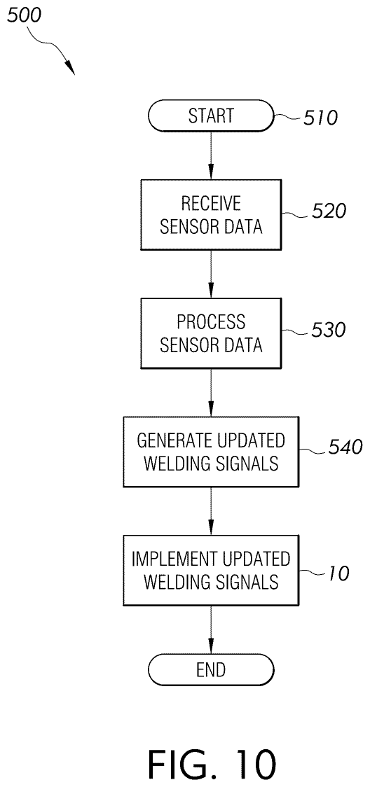

FIG. 10 illustrates an example methodology/control logic for executing a welding signal adjustment process based on sensor data in real time, e.g., motion data captured by motion sensor 130 (FIG. 3), welding current feedback via current sensor 132 (FIG. 3), or voltage feedback via voltage sensor 134 (FIG. 3).

In this embodiment, at block 510, a welding process is initiated. At block 520, the controller may receive sensor data, including, for example, motion data (e.g., a position and orientation of a welding torch relative to a welded workpiece). The controller 120 may also receive current feedback and or voltage feedback, At block 530, the methodology may include processing the sensor data. This may include, for example, utilizing the processor 136 (FIG. 3) to executes software (e.g., an artificial intelligence model or algorithm) to detect patterns in the sensor data based on the detected sensor data, e.g., sensor drift. The processor 136 may also derive an absolute position and/or orientation of the welding torch 150 (FIG. 3) based on the coordinates of the motion sensor 130 and/or other examples of motion data, The absolute position and/or orientation may be refined to eliminate noise (e.g., sensor drift).

At block 540, the controller 120 may generate updated welding signals based on the sensor data, or refined sensor data. For instance, the controller 120 adjust any one of a welding waveform type, a welding current, an output voltage, or wire feed speed based on the sensor data, for instance, at each of a plurality of positions along a weld path. The process may end after completing a weld, e.g., at the end of a weld path.

While embodiments of the present disclosure described herein are discussed in the context of GMAW type welding, other embodiments of the invention are not limited thereto. For example, embodiments can be utilized in SAW, FCAW, MCAW, or GTAW type welding operations, as well as other similar types of deposition operations. For example, in embodiments, the welding torch may embody a GTAW torch with a non-consumable electrode operatively connected to a constant current power source, and the waveform types may comprise AC or variable polarity waveforms, or a pulsed waveform type. In some embodiments, the welding system may include a means (e.g., a power source) to resistively preheat the welding wire to facilitate hot wire welding, and the controller may comprise logic to generate an updated welding signal (e.g., preheating current) at each of a plurality of positions along a weld path.

Further, embodiments of the present invention can be used in manual, semi-automatic and robotic welding operations. Embodiments of the present invention can also be used in metal deposition operations that are similar to welding, such as additive manufacturing, hard facing, and cladding. As used herein, the term “welding” is intended to encompass all of these technologies as they all involve material deposition to either join or build up a workpiece.

Therefore, in the interests of efficiency, the term “welding” is used below in the description of exemplary embodiments, but is intended to include all of these material deposition operations, whether or not joining of multiple workpieces occurs.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. A welding system comprises:
a welding torch including a sensor, wherein the welding torch is configured to establish an arc to produce a molten weld puddle, wherein the sensor is configured to detect motion data representative of a position and/or orientation of the welding torch at a first location and at a second location along a weld path;
a controller communicatively coupled to the sensor, wherein the controller comprises logic to:
receive the motion data;
generate an updated welding signal based on the motion data and a corresponding difference in an effect of gravity on the molten weld puddle between the first location and the second location along the weld path, wherein the updated welding signal includes a first waveform type at the first location and a second waveform type at the second location; and
implement the first and second waveform types during a welding process.

2. The welding system of claim 1, wherein the motion data comprises a travel speed, the position, and the orientation of the welding torch relative to the weld path.

3. The welding system of claim 1, wherein the first waveform type differs from the second waveform type.

4. The welding system of claim 3, wherein the first waveform type includes a first pinch current level and the second waveform type includes a second pinch current level, wherein the first pinch current level exceeds the second pinch current level.

5. The welding system of claim 3, wherein the first waveform type includes a first peak current level and the second waveform type includes a second peak current level, wherein the first peak current level exceeds the second peak current level.

6. The welding system of claim 1, wherein the controller further comprises logic to:
process the motion data via an artificial intelligence model to generate a first absolute position and orientation of the welding torch at the first location along the weld path, generate a second absolute position and orientation of the welding torch at the second location along the weld path, and
generate the first waveform type based on the first absolute position and orientation, and generate the second waveform type based on the second absolute position and orientation.

7. The welding system of claim 6, wherein the artificial intelligence model comprises a neural network comprising an input layer, one or more hidden layers, and an output layer, wherein the artificial intelligence model receives the motion data at the input layer to determine the first absolute position and orientation and the second absolute position and orientation at the output layer.

8. The welding system of claim 1, wherein the system further comprises a welding power source, wherein the welding power source includes a pulse width modulator component, and wherein the controller comprises logic to control the pulse width modulator component to execute the updated welding signal.

9. The welding system of claim 1, wherein the first waveform type includes a background current level, a pinch current level, a peak current level, and a low current level, wherein the low current level is less than the background current level, and wherein the controller comprises logic to execute the low current level when welding wire supplied via the welding torch shorts a workpiece.

10. A method of adjusting a welding signal during a welding process, wherein the method comprises:
receiving a first position and orientation of a sensor at a first point along a weld path;
receiving a second position and orientation of the sensor at a second point along the weld path, wherein an effect of gravity on the molten weld puddle at the first point is different than at the second point;
generating a first updated welding signal based on the first position and orientation, wherein the first updated welding signal comprises a first waveform type; and
generating a second updated welding signal based on the second position and orientation, wherein the second updated welding signal comprises a second waveform type, wherein the second waveform type differs from the first waveform type.

11. The method of claim 10, wherein the first waveform type includes a first pinch current level, and wherein the second waveform type includes a second pinch current level, wherein the second pinch current level is different than the first pinch current level.

12. The method of claim 10, wherein the method further comprises:
implementing the first updated welding signal at the first point along the weld path; and
implementing the second updated welding signal at the second point along the weld path.

13. The method of claim 10, wherein the method further comprises:
processing the first position and orientation as an input to an artificial intelligence model to determine a first absolute position and orientation of the welding torch relative to the weld path at the first point;
processing the second position and orientation of the sensor as another input to the artificial intelligence model to determine a second absolute position and orientation of the welding torch relative to the weld path at the second point;
generating the first updated welding signal based on the first absolute position and orientation; and
generating the second updated welding signal based on the second absolute position and orientation.

14. The method of claim 10, wherein the method further comprises:
executing a pulse width modulation control to implement the first updated welding signal at the first point; and
executing the pulse width modulation control to implement the second updated welding signal at the second point.

15. The method of claim 10, wherein the sensor comprises an inertial measurement unit affixed to a welding torch during the welding process, wherein the inertial measurement unit comprises at least one of an accelerometer, gyroscope, and magnetometer.

16. The method of claim 10, wherein the first waveform type includes a first peak current level, and wherein the second waveform type includes a second peak current level, wherein the second peak current level is different than the first peak current level.

17. The method of claim 10, wherein the first waveform type includes a first background current level, and wherein the second waveform type includes a second background current level, wherein the first background current level is different than the second background current level.

18. A system for welding comprises:
a welding power source including output circuitry configured to generate a welding signal;
a welding torch operatively connected to the welding power source, wherein the welding torch is configured to generate a molten weld puddle at a first location and at a second location along a weld path;
a sensor affixed to the welding torch; and
a controller including a processor, wherein the processor includes logic to:
receive sensor data from the sensor, wherein the sensor data comprises at least one of a position and/or orientation of the welding torch at the first location and at the second location;
generate a first updated welding signal at the first location along the weld path based on the sensor data at the first position location, wherein the first updated welding signal includes a first waveform type accounting for the effect of gravity on the molten weld puddle at the first location; and
generate a second updated welding signal at the second location along the weld path based on the sensor data at the second location, wherein the second updated welding signal includes a second waveform type accounting for the effect of gravity on the molten weld puddle at the second location, wherein the effect of gravity on the molten weld puddle differs between the first location and the second location.

19. The system of claim 18, wherein the first waveform type is different than the second waveform type.

20. The system of claim 18, wherein the controller further comprises logic to:
control the output circuitry of the welding power source to implement the first welding signal at the first position along the weld path; and
control the output circuitry to implement the second welding signal at the second position along the weld path.
